(19) United States
(12) Patent Application Publication
(10) Pub. No.: US 2009/0227338 A1
(43) Pub. Date: Sep. 10, 2009

(54) Slot Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE CORP., Tokyo (JP)

(21) Appl. No.: 12/270,228

(22) Filed: Nov. 13, 2008

Related U.S. Application Data
(60) Provisional application No. 61/034,631, filed on Mar. 7, 2008.

(51) Int. Cl. A63F 13/00

(52) U.S. Cl. 463/20

(57) ABSTRACT

A slot machine according to the present invention includes a display device having a symbol display region for displaying plural types of symbols; a memory for storing image data concerning the plural types of symbols; and a processor for controlling the display device and the memory. The plural types of symbols contain a plurality of symbol groups. Each of the symbol groups is made up of a plurality of step-up symbols. Each of the step-up symbols expresses a different added-value. The processor is programmed to: (a) read the image data concerning the plural types of symbols from the memory; (b) execute a game by processing the image data, the game for rearranging the plural types of symbols in the symbol display region; (c) rearrange at least the one or more symbols, in the case where the two or more symbols are rearranged in the symbol display region, in a predetermined period of time delay after previous symbol arrangement; and (d) exercise control to set the symbol rearranged in the predetermined period of time delay to a step-up symbol expressing an added-value higher than that of the previously-rearranged symbol, in the case where these symbols belong to the same symbol group.

### CROSS-REFERENCE TO RELATED APPLICATIONS

This application claims priority of U.S. Provisional Application No. 61/034,631 filed on Mar. 7, 2008. The contents of this application are incorporated herein by reference in their entirety.

### BACKGROUND OF THE INVENTION

1. Field of the Invention

The present invention relates to a slot machine.

2. Description of the Related Art

Slot machines known as a type of gaming machines are constituted so as to: start games by players inserting credit into the gaming machine; rearrange columns of symbols in predetermined region of the gaming machine; and award payout based on a combination of rearranged symbols. In addition, the above slot machines are generally constituted to judge whether or not a precondition for payout has been established, based on whether or not a predetermined number of symbols of the same type (for example, “CHERRY” or “7”) are arranged along a preset payline. In the conventional slot machine, in the case where a predetermined number or more of symbols of the same type are arranged, it has been a common routine to award payout based on the number of the aforementioned arranged symbols, regardless of the payout line.

Therefore, layouts of arranged symbols or designs of payline are important factors in games, thereby becoming a focus of attention by providers or players of gaming machines. U.S. Pat. No. 6,896,615-B2 discloses an art in which the variety of payout is increased by arranging symbols after breaking elements in three rows and five columns of matrix display into more.

On the other hand, in addition to mechanical reel-type slot machines, that have been conventionally mainstream, video reel-type slot machines provided with an electronic display screen are put into practical use, thereby increasing flexibility in expression or layout of symbols on the screen. Therefore, improvement in entertainability has been a challenge, which is to be achieved by adding visual expression to attract players' interest to games beyond concepts of conventional simple layouts of symbols or designs of paylines.

The present invention has been made in view of the above-described circumstance. It is an object of the present invention to provide a novel slot machine and a controlling method thereof by adding active expression to symbols arranged on a display of a slot machine.

### SUMMARY OF THE INVENTION

A first aspect of the present invention is a slot machine including a display device having a symbol display region for displaying plural types of symbols; a memory for storing image data concerning the plural types of symbols; and a processor for controlling the display device and the memory. The plural types of symbols contain a plurality of symbol groups. Each of the symbol groups is made up of a plurality of step-up symbols. Each of the step-up symbols expresses a different added-value. The processor is programmed to: (a) read the image data concerning the plural types of symbols from the memory; (b) execute a game by processing the image data, the game for rearranging the plural types of symbols in the symbol display region; (c) rearrange at least the one or more symbols, in the case where the two or more symbols are rearranged in the symbol display region, in a predetermined period of time delay after previous symbol arrangement; and (d) exercise control to set the symbol rearranged in the predetermined period of time delay to a step-up symbol expressing an added-value higher than that of the previously-rearranged symbol, in the case where these symbols belong to the same symbol group.

According to the first aspect, a specific symbol is changed to express a higher value in accordance with a game progress. For example, in the case where the specific symbol is set to a bonus symbol, change of symbol allows players to play the game with expectations for bonus wining, thereby enhancing entertainability in symbol rearrangement.

A second aspect of the present invention is a slot machine constituted as set fourth below. In the first aspect, the processor replaces the previously-rearranged symbol belonging to the same symbol group with the step-up symbol expressing the higher added-value, in the case where the step-up symbol expressing the higher added-value is rearranged in the itemized (d).

According to the second aspect, the symbol expressing a higher value is arranged on the display device, which raises players' expectations for prize wining, thereby enhancing entertainability in symbol rearrangement.

A third aspect of the present invention is a slot machine constituted as set fourth below. In the first aspect, the processor exercises control in a manner to display an image of the step-up symbol in the case where the image of the step-up symbol is superimposed on an image of an adjacent symbol.

According to the third aspect, in the case where an image of a specific symbol to be rearranged is larger than that of the regular symbol, the regular symbol is not displayed and the specific symbol is displayed in preference to the specific symbol. Therefore, the symbol expressing a higher added-value is displayed with emphasis, thereby further improving visual effects.

A fourth aspect of the present invention is a slot machine constituted as set fourth below. In the first aspect, the processor awards a payout corresponding to the added-value of the step-up symbol rearranged in the itemized (d), in the case where a predetermined condition is met.

According to the fourth aspect, the symbol on which players focus attention expresses the amount of winnable payout, thereby raising players' expectations for prize.

### BRIEF DESCRIPTION OF THE DRAWINGS

FIG. 1A is a view showing an exemplary symbol matrix according to an embodiment of the present invention;

FIG. 1B is a view showing an exemplary symbol matrix according to the embodiment of the present invention;

FIG. 1C is a view showing an exemplary symbol matrix according to the embodiment of the present invention;

FIG. 2 is a perspective view schematically showing a frame format of a slot machine according to the embodiment of the present invention;

FIG. 3 is a view showing an internal construction of the slot machine shown in FIG. 2;

FIG. 4A is a view showing an exemplary symbol matrix according to the embodiment of the present invention;

FIG. 4B is a view showing an exemplary symbol matrix according to the embodiment of the present invention;

FIG. 5A is a view showing an exemplary symbol matrix related to bonus award according to the embodiment of the present invention;

FIG. 5B is a view showing an exemplary symbol matrix related to the bonus award according to the embodiment of the present invention;

FIG. 5C is a view showing an exemplary symbol matrix related to the bonus award according to the embodiment of the present invention;

FIG. 6A is a view showing an exemplary symbol matrix related to the bonus award according to the embodiment of the present invention;

FIG. 6B is a view showing an exemplary symbol matrix related to the bonus award according to the embodiment of the present invention;

FIG. 6C is a view showing an exemplary symbol matrix related to the bonus award according to the embodiment of the present invention;

FIG. 7 is a flowchart showing a subroutine of a main process according to the embodiment of the present invention;

FIG. 8 is a flowchart showing a subroutine of a game execution process according to the embodiment of the present invention;

FIG. 9 is a flowchart showing a subroutine of a symbol rearrangement process for the bonus award according to the embodiment of the present invention; and

FIG. 10 is a flowchart showing a subroutine of the symbol rearrangement process for the bonus award according to the embodiment of the present invention.

### DESCRIPTION OF THE PREFERRED EMBODIMENTS

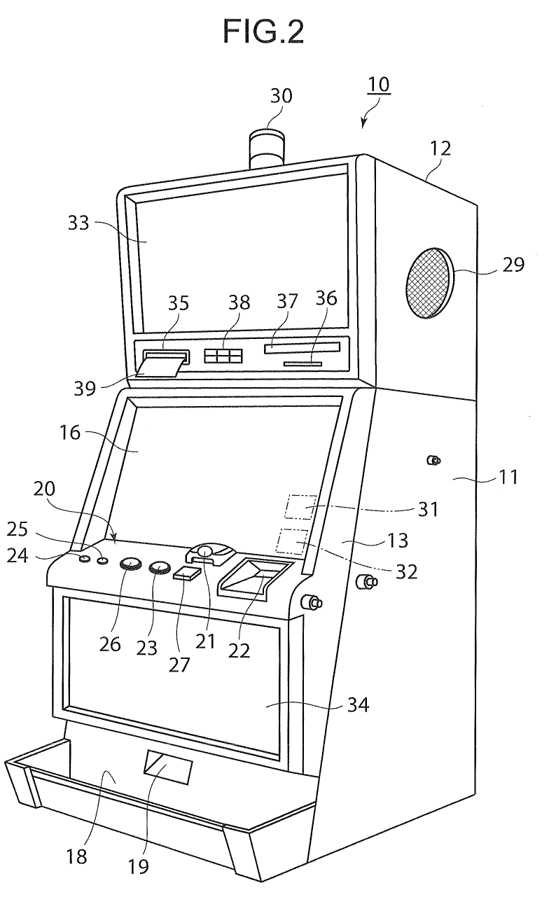

First, a slot machine 10 (see FIG. 2) according to an embodiment of the present invention will be described with referring to the drawings. The slot machine according to the embodiment of the present invention is a so-called video slot machine, which has an image display panel such as a liquid crystal display and executes a game by displaying various images of symbols in a matrix form on the image display panel. The slot machine 10 according to the present invention executes two gaming modes alternately. The two gaming modes include a basic game and a free game. The basic game is executed upon consumption of inserted gaming values bet by players, namely, a credit. The free game is executed without consuming credits. Further, a bonus is awarded and a jackpot is won in the case where a bonus symbol is rearranged under a predetermined condition. As described later, symbols to be rearranged on the image display panel contains a plurality of symbol groups corresponding to types of bonus to be awarded, including a symbol group made up of a plurality of step-up symbols. Further, the step-up symbols are displayed so as to express different added-values, respectively. While the slot machine 10 is of a stand-alone type, which is not connected to a network, the present invention is also applicable to a networked slot machine.

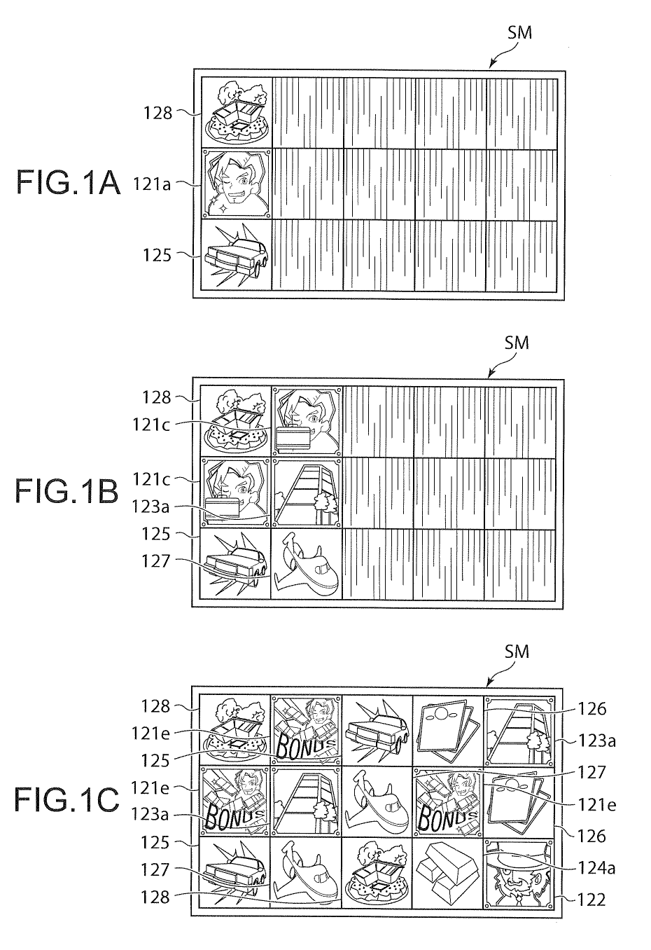

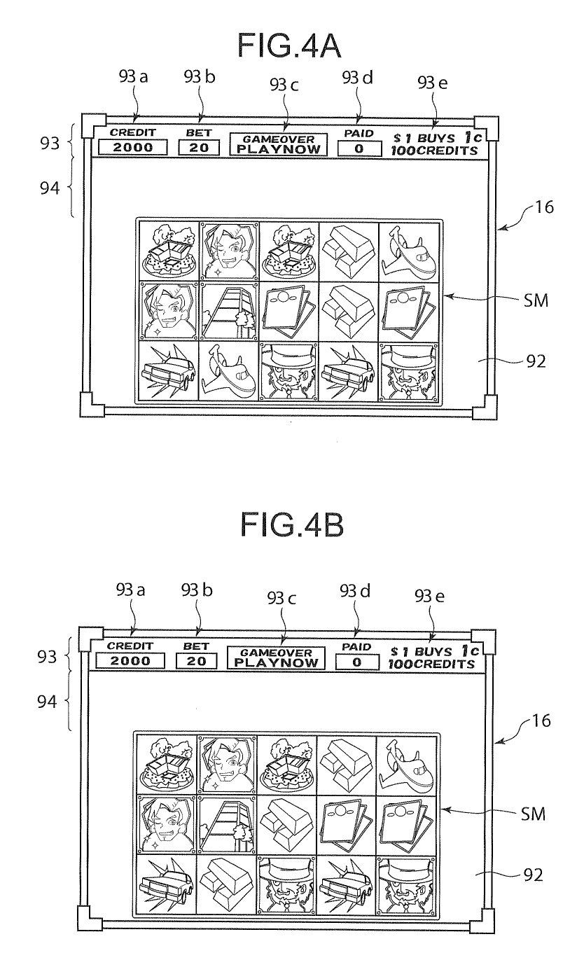

FIGS. 1A to 1C are views each showing an example case where symbols are rearranged in a symbol matrix SM (see FIGS. 4A and 4B) during a basic game according to the embodiment of the present invention. The symbol matrix SM is displayed on a lower image display panel 16 included in the slot machine 10 to be described later. The symbol matrix SM is made up of elements in five columns and three rows allowing symbols to be rearranged therein. The example cases shown in FIGS. 1A to 1C illustrate symbol rearrangement in the symbol matrix SM in the case where the bonus award is internally determined. As a precondition for a bonus award, the bonus to be paid out is a regular-size jackpot referred to as “MIN”.

Each of the symbols “main character” 121a, “car” 125, and “villa” 128 is rearranged on a first column in the symbol matrix SM shown in FIG. 1A. The other columns display image effects in a scrolling manner. In this case, the symbol “main character” 121a, a symbol “briefcase” 121c shown in FIG. 1B, and a symbol “bonus character” 121e are set to step-up symbols making up one symbol group. An added-value increases in order of the symbols 121a, 121c, and 121e. A grade of the jackpot to be awarded is “MIN”, so that a group containing the symbol “bonus character” 121e is selected as a symbol group corresponding to a bonus.

In FIG. 1B, the symbols “briefcase” 121c, “office building” 123a, and “jet” 127 are rearranged on a second column, and third to fifth columns display image effects in a scrolling manner. Further, the symbol “main character” 121 a previously rearranged on the first column is replaced with the symbol “briefcase” 121c.

In FIG. 1C, symbols “sub character” 122, “office building” 123a, “gold bullion” 124a, “car” 125, “stock certificate” 126, “jet” 127, “villa” 128, and “bonus character” 121e are rearranged on the third to fifth columns. The previously-rearranged two symbols “briefcase” 121c shown in FIG. 1B are replaced with the symbols “bonus character” 121e. Rearrangement of the three symbols “bonus character” 121e ultimately determines the bonus award in terms of screen display.

As described above, symbols are rearranged in stages on column-by-column basis at a predetermined time interval. Further, image effects that the bonus symbol “main character” 121a steps up are displayed. In this manner, the slot machine produces effects of appealing entertainability to players.

FIG. 2 is a view schematically depicting a frame format of an appearance of the slot machine according to the embodiment of the present invention. The gaming media used in the slot machine 10 include coins, bills, or electronic value information equivalent thereto. In the present invention, however, the gaming media are not limitative thereto in particular, and can include medals, tokens, electric money, and tickets, for example. The above tickets are not limitative in particular, and can include barcode-attached tickets or the like, as described later, for example.

The slot machine 10 is provided with a cabinet 11, a top box 12 installed on an upper side of the cabinet 11, and a main door 13 provided on a front surface of the cabinet 11.

The lower image display panel 16 serving as a display device is provided in front of the main door 13. The lower image display panel 16 is provided with a liquid crystal panel, which displays the symbol matrix SM in three rows and five columns. A single symbol is arranged in each of the elements of the symbol matrix SM, and the maximum of fifteen symbols can be displayed therein.

A credit amount display section 31 of the lower image display panel 16 displays a by way of an image, credit corresponding to the number of inserted coins. A payout amount display unit 32 displays by way of an image, a combination of rearranged symbols or the number of coins to be paid if the predetermined number of symbols are rearranged.

Provided on the lower side of the lower image display panel 16 at a center of the main door 13 is a control panel 20 on which a plurality of buttons 23 to 27 through which command regarding the process of the game is entered, a coin receiving slot 21 for receiving coins into the cabinet 11, and bill validator 22 are disposed.

On the control panel 20, a start button 23, a change button 24, a cashout button 25, a 1-BET button 26, and a MAX-BET button 27 are provided. The start button 23 is intended for entering a command for starting the game. The change button 24 is intended for use in asking an attendant of the gaming facility for change. The cashout button 25 is intended for entering a command for paying out the credited coins to a coin tray 18 through a coin payout exit 19.

The 1-BET button 26 is intended for entering a command for betting a credit corresponding to one coin. The MAX-BET button 27 is intended for entering a command for betting the maximum number (fifty in this embodiment) of coins that can be bet per game. Part of credit that is input through those input units is cumulatively stored in a predetermined memory region of the RAM 43 and a cumulative value is used as the reference to determine the amount of so-called jackpot in the case of bonus award.

The bill validator 22 validates whether or not a bill is legitimate and accepts a legitimate bill into the cabinet 11. The bill validator 22 may be configured so that a barcode-attached ticket 39 described later is readable thereby. Provided on a lower front surface of the main door 13, that is, at a lower part of the control panel 20, is a berry glass 34 on which characters of the slot machine 10 and the like are depicted.

On a front surface of the top box 12, an upper image display panel 33 is provided. The upper image display panel 33 has a liquid crystal panel, which displays images for introducing the game contents or explaining game rules, for example.

Also, on the top box 12, a speaker 29 and a lamp 30 are provided. On a lower side of the upper image display panel 33, a ticket printer 35, a card reader 36, a data display unit 37, and a key pad 38 are provided. The ticket printer 35 prints, on tickets, bar-codes having coded therein a variety of data including a credit amount, data and time, and an identification number of slot machine 10. The printed tickets are output as bar-code-attached tickets 39. A player causes another slot machine to read the bar-code-attached tickets 39, allowing the slot machine to perform games, or alternatively, allowing the exchange of bar-code-attached tickets 39 with bills or the like at a predetermined site of a game facility (for example, at the casher in a casino).

The card reader 36 reads data from and write data into a smart card. The smart card is to be owned by the player, which stores data for identifying the player or data regarding the log of games executed by the player, for example. The smart card may store data corresponding to coins, bills, or a credit. As an alternative of a smart card, a magnetic stripe card may be employed. The data display 37 is made up of a fluorescent display and the like, and displays the data read by the card reader 36 or the data input by the player through the key pad 38, for example. The key pad 38 inputs data and commands regarding the ticket issuance or the like.

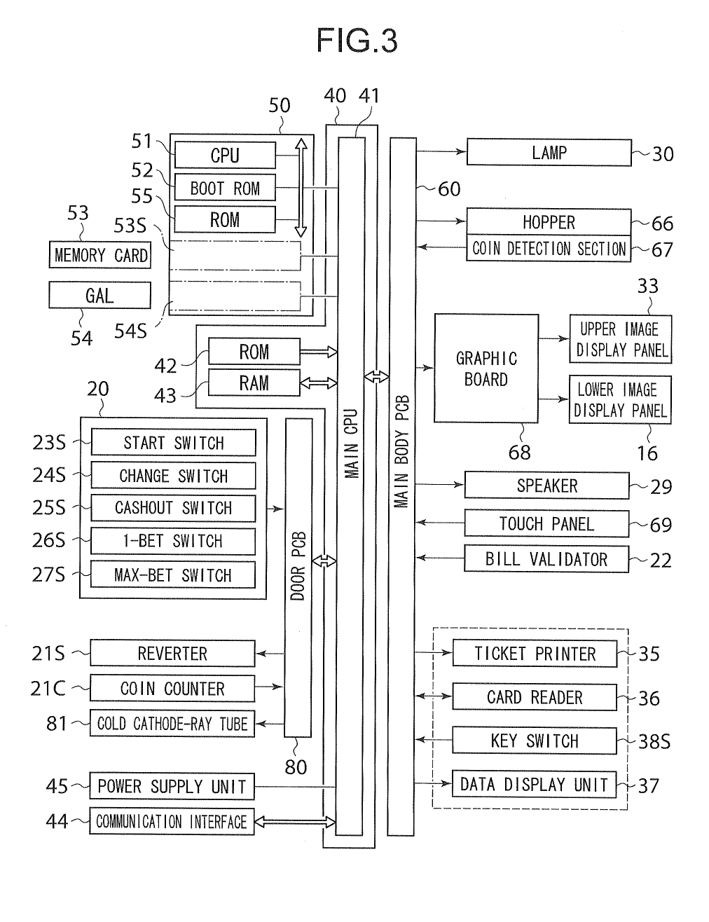

FIG. 3 is a block diagram depicting the internal construction of the slot machine shown in FIG. 2. A gaming board 50 includes: a CPU (Central Processing Unit) 51, a ROM (Read-only Memory) 55 and a boot ROM 52 interconnected by an internal bus; a card slot 53S corresponding to a memory card 53; and an IC socket 54S corresponding to a GAL (Generic Array Logic) 54.

The memory card 53 contains therein a nonvolatile memory and stores game programs. The game programs include a symbol selection program. The aforementioned symbol selection program is intended for determining the symbols to be rearranged in the elements of the symbol matrix SM. The aforementioned symbol selection program includes symbol weighing data respectively corresponding to plural types of payout ratios (80%, 84%, and 88%, for example). The symbol weighing data is indicative of the correspondence relationship between the respective symbols and one or more random numeric values which come under a predetermined numerical range (0 to 255). The payout ratio is determined according to the payout-ratio setting data output from the GAL 54. The symbols to be rearranged in the symbol matrix SM are determined depending upon the symbol weighing data corresponding to this payout ratio. Further, the game programs include table data indicating the correspondence relationship between each of the symbols and a payout.

Also, the card slot 53S is configured to allow the memory card 53 to be inserted thereinto or ejected therefrom, and is connected to a motherboard 40 through an IDE pass. Accordingly, the memory card 53 can be ejected from the card slot 53S, other game programs and other game system programs can then be written into the memory card 53, and further, the memory card 53 can be inserted into the card slot 53S, thereby allowing the player to change the types and contents of games executed in the slot machine 10. The game program includes programs concerning a game progress. Furthermore, the game program includes image data or sound data to be output during the game. Furthermore, the game program includes image data or sound data to be output during the game. This image data includes image data concerning symbols rearranged in the symbol matrix SM, for example.

The GAL 54 is a type of a PLD having a fixed OR array structure. The GAL 54 includes plural input ports and plural output ports. Where predetermined data is input to the input port, the GAL 54 outputs data corresponding to the aforementioned data from the output port. The data output from this output port is equivalent to the aforementioned payout-ratio setting data. Also, the IC socket 54S is configured to allow the memory card 54 to be inserted thereinto or ejected therefrom, and is connected to a motherboard 40 through PCI bus. Accordingly, the GAL can be replaced with a replacement GAL 54 to change the payout-ratio setting data.

The CPU 51, the ROM 55, and the boot ROM 52 interconnected by the internal bus are connected to the motherboard 40 by the PCI bus. The PCI bus serves to transmit signals between the motherboard 40 and the gaming board 50 and supply power from the motherboard 40 to the gaming board 50. The motherboard 40 is constructed with a commercially available general-purpose motherboard (a printed circuit board on which the essential parts of a personal computer are mounted).

The motherboard 40 is constructed using a general-purpose motherboard commercially available (a printed circuit board on which essential parts of a personal computer are mounted) and includes: a main CPU (Central Processing Unit) 41, a ROM (Read-only Memory) 42; a RAM (Random Access Memory) 43; and a communication interface 44.

The ROM 42 stores thereon a program such as BIOS (Basic Input/Output System) executed by the main CPU 41, and permanent data. When the BIOS is executed by the main CPU 41, processing of initializing predetermined peripheral devices is carried out and processing of capturing game programs and game system programs stored in the memory card 53 through the gaming board 50 is started. In the present invention, the contents of the ROM 42 may be rewritable or not.

The RAM 43 stores data and a program used when the main CPU 41 is activated. The RAM 43 can also store game programs. The RAM 43 further stores data concerning the credit amount, the number of coin-in or coin-out for one game, and the like.

Both a main body PCB (Printed Circuit Board) 60 and a door PCB 80 are connected to the motherboard 40 by USB. A power supply unit 45 is also connected to the motherboard 40.

Equipment and devices, which generate input signals to be input to the main CPU41, and equipment and devices, operations of which are controlled by a control signal output from the main CPU41, are connected to the body PCB60 and the door PCB80. The main CPU41 executes the game programs stored in RAM 43, based upon an input signal that was input to the main CPU41, thereby performing predetermined computational processing. Then, this CPU41 stores results thereof into RAM43; and transmits control signals to equipment and devices as control processing relative to the equipment and devices.

Connected to the main body PCB 60 are a lamp 30, a hopper 66, a coin detecting section 67, a graphic board 68, a speaker 29, a touch panel 69, a bill validator 22, a ticket printer 35, a card reader 36, a key switch 38S, and a data display 37. The lamp 30 illuminates in a predetermined pattern, based on a control signal output from a main CPU 41. The lamp 30 is lit up in a predetermined pattern, based upon a control signal output from the main CPU41.

The hopper 66 is installed in the cabinet 11. This hopper pays out a predetermined number of coins from a coin payout exit 19 to a coin tray 18, based upon a control signal output from the main CPU41. A coin detecting section 67 is installed inside the coin payout exit 19. This detecting section outputs an input signal to the main CPU41 at the time of detecting that a predetermined number of coins have been paid out from the coin payout exit 19.

The graphic board 68 performs control, based upon a control signal output from the main CPU41, over image display on the upper image display panel 33 and the lower image display panel 16. The credit amount display section 31 (see FIG. 2) on the lower image display panel 16 displays the amount of credits stored in the RAM43. Further, the payout amount display section 32 (see FIG. 2) on the lower image display panel 16 displays the number of coins to be paid out. The graphic board 68 is equipped with: a VDP (Video Display Processor), which generates image data based upon a control signal output from the main CPU41; and a video RAM, which temporarily stores image data generated by the VDP or the like. The image data used in generating the image data with VDP is contained in the game program read from the memory card 53 and stored in the RAM 43.

The bill validator 22 validates whether or not a bill is legitimate and accepts a legitimate bill into the cabinet 11. The bill validator 22, upon accepting a legitimate bill, outputs an input signal to the main CPU 41 based on the bill amount. The main CPU 41 stores in the RAM 43 the credit amount corresponding to the bill amount transmitted by the input signal.

Based on a control signal output from the main CPU 41, the ticket printer 35 prints on a ticket a barcode having encoded thereon data such as the credit amount, data and time, and the identification number of the slot machine 10 stored in the RAM 43. Further, this printer outputs the printed ticket as a barcode-attached ticket 39. The card reader 36 transmits, to the main CPU41, the data read from the smart card, and writes the read data onto the smart card, based upon a control signal from the main CPU41. The key switch 38S is provided on the key pad 38, and outputs a predetermined input signal to the main CPU41 when a player operates the key pad 38. The data display 37 displays, based upon a control signal output from the main CPU41, the data read by the card reader 36 and the data input by a player through the key pad 38. The control panel 20, a reverter 21S, a coin counter 21C, and a cold cathode-ray tube 81 are connected to the door PCB80.

The control panel 20, a reverter 21S, a coin counter 21C, and a cold cathode tube 81 are connected to the door PCB 80. The control panel 20 is provided with: a start switch 23S corresponding to the start button 23; a change switch 24S corresponding to the change button 24; a cashout switch 25S corresponding to a cashout button 25; a 1-BET switch 26S corresponding to a 1-BET button 26; and a MAX-BET switch 27S corresponding to the MAX-BET button 27. When the player operates the buttons 23 to 27, the corresponding switches 23S to 27S output input signals to the main CPU 41, respectively.

The coin counter 21C is provided inside the coin receiving slot 21, and validates whether or not a coin inserted into the coin receiving slot 21 is legitimate. Those other than the legitimate coins are discharged from the coin payout exit 19. The coin counter 21C also outputs an input signal to the main CPU41 when a legitimate coin is detected.

The reverter 21S operates based on a control signal output from the main CPU41 and distributes coins recognized as being legitimate by the coin counter 21C into a cash box (not shown in the drawings) or the hopper 66 which is arranged in the slot machine 10. Specifically, when the hopper 66 is filled with coins, the reverter 21S distributes legitimate coins into the hopper 21S. On the other hand, when the hopper 66 is not filled with coins, legitimate coins are distributed into the hopper 66. The cold-cathode tube 81 functions as a backlight installed on a rear face side of each of the lower image display panel 16 and the upper image display panel 33, and is lit up based on a control signal output from the main CPU 41.

FIGS. 4A to 6B are views each showing an exemplary image displayed on the lower image display panel 16 of the slot machine 10 shown in FIG. 2 according to the embodiment of the present invention. FIGS. 4A and 4B are views each showing an exemplary image displayed during the basic game in the slot machine shown in FIG. 2.

As shown in FIG. 4A, the lower image display panel 16 is made up of a display region 92, an information display section 93, an effect image display section 94, and the like. The display area section 92 is for displaying the symbol matrix SM. On both sides of the symbol matrix SM, the icons indicative of the number of coins that have been bet are arranged, and control is exercised to blink the icon corresponding to the bet amount. The information display section 93 is arranged upwardly of the display region 92 and is made up of a credit amount display section 93a, a BET amount display section 93b, a character information display section 93c, a PAID amount display section 93d, and a charge display section 93e.

The number of coins currently credited is displayed at the credit amount display section 93a while the number of coins bet on one game is displayed at the BET amount display section 93b. The character information indicative of a current status of the game is displayed at the character information display section 93c. The characters of “PLAYNOW” are displayed during the play of the game, whereas the characters of “GAMEOVER” are displayed during the intervals between the plays of the game. The number of coins that have been paid out in one game is displayed at the PAID amount display section 93d, whereas a conversion value of the credit amount based on a predetermined amount of money is displayed at the charge display section 93e.

The effect image display section 94 displays effect images according to a type of the slot game. In other words, the effect image display section 94 displays different effect images between the basic and free games.

Any of symbols, “main character” 121a, “sub character” 122, “office building” 123a, “gold bullion” 124a, “car” 125, “stock certificate” 126, “jet” 127, and “villa” 128 are rearranged in the symbol matrix SM displayed on the lower image display panel 16. A payout is determined based on the number of these symbols displayed in the symbol matrix SM.

FIG. 4A is a view showing an example case where the symbols, “main character” 121a, “sub character” 122, “office building” 123a, “gold bullion” 124a, “car” 125, “stock certificate” 126, “jet” 127, and “villa” 128 are rearranged in the symbol matrix SM during the basic game. In FIG. 4A, the two symbols “main character” 121 a are rearranged, the symbols being set to a trigger for switching the game from the basic game to the free game The condition to start the free game is met when the three or more symbols “main character” 121a are rearranged. This condition is not met in the above case, so that the basic game is continued without staring the free game.

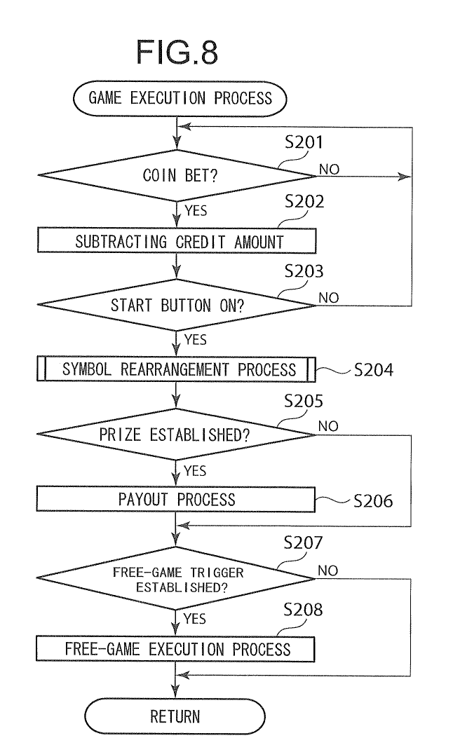

FIG. 4B is a view showing an example case where symbols are rearranged in the symbol matrix SM during the basic game. In this case, the three symbols “gold bullion” 124a are rearranged in the symbol matrix SM. In the first embodiment of the present invention, a prize has been established when the three or more identical symbols are rearranged. In this case, coins are paid out, the number of which corresponds to a prize set for the symbol “gold bullion” 124a (see FIG. 8, step S206).

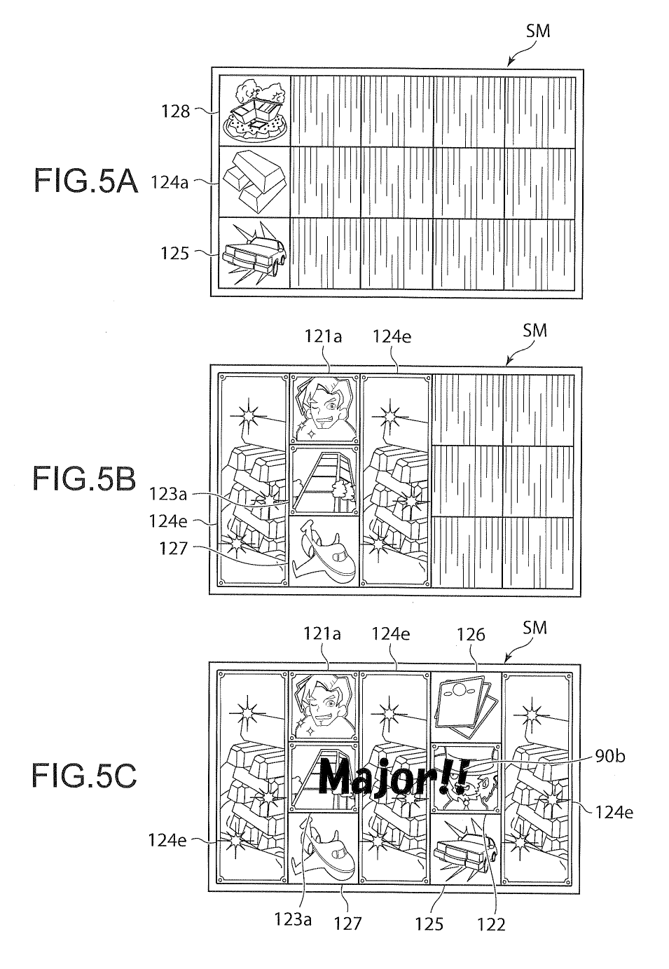

FIGS. 5A to 5C are views each illustrating, likewise FIGS. 1A to 1C, symbol rearrangement in the symbol matrix SM performed in the case where the bonus award is internally determined. In the case shown in FIGS. 5A to 5C, a cumulative value of part of bet credit that is cumulatively stored in the RAM 43, the value being referred to as a progressive value, reaches a predetermined value. Thus, ajackpot corresponding to “MAJOR” is paid out.

In FIG. 5A, each of the symbols “gold bullion” 124a, “car” 125, and “villa” 128 is rearranged on the first column. The second to fifth columns display effect images in a scrolling manner. In this case, the symbol “gold bullion” 124a and a symbol “gold bullion tower” 124e shown in FIG. 5B are set to step-up symbols making up one symbol group. An added-value of the symbol 124e is higher than that of the symbol 124a. A grade of the jackpot to be awarded is “MAJOR”, so that a group containing the symbol “gold bullion tower” 124e is selected as a symbol group corresponding to a bonus.

In FIG. 5B, the symbols “main character” 121a, “office building” 123a, and “jet” 127 are rearranged on the second column while the symbol “gold bullion tower” 124e is rearranged on the third column. The fourth and fifth columns display effect images in a scrolling manner. The symbol “gold bullion” 124a previously rearranged on the first column is replaced with the symbol “gold bullion tower” 124e. The symbol “gold bullion tower” 124e is longitudinally extended, thereby being superimposed on each of the symbols “car” 125 and “villa” 128 that are previously rearranged on the first column. In this case, display is controlled so that the symbol “gold bullion tower” 124e as a step-up symbol is preferentially displayed.

Next, in FIG. 5C, the symbols “sub character” 122, “car” 125, and “stock certificate” 126 are rearranged on the fourth column and the symbol “gold bullion tower” 124e is rearranged on the fifth column. Rearrangement of the three symbols “gold bullion tower” 124e ultimately determines the bonus award corresponding to “MAJOR” in terms of screen display.

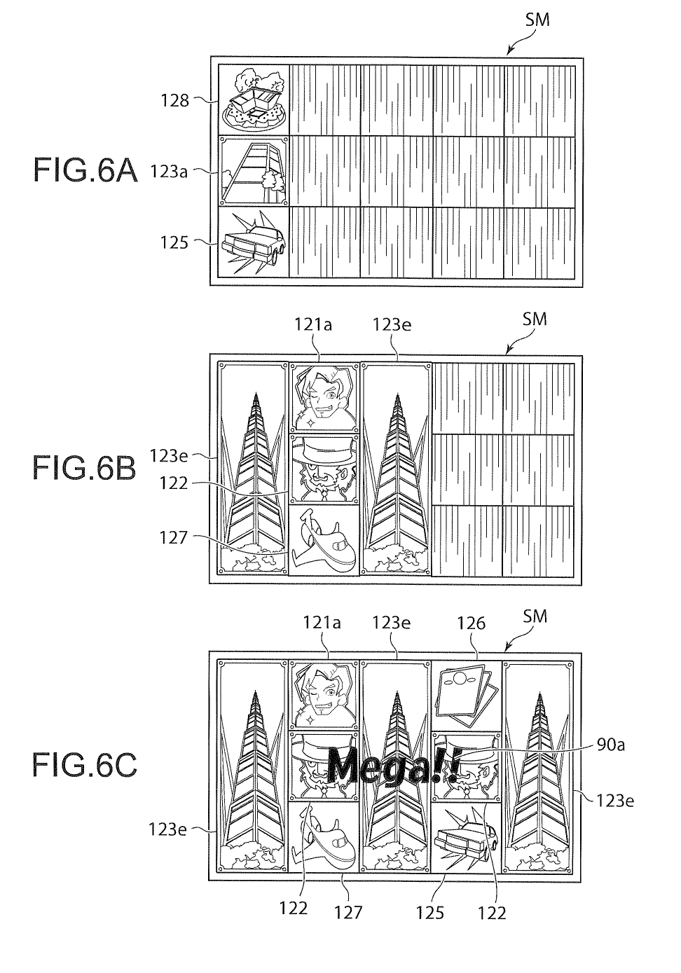

FIGS. 6A to 6C are views each illustrating, likewise FIGS. 1A to 1C and 5A to 5C, symbol rearrangement in the symbol matrix SM in the case where the bonus award is internally determined. In the case shown in FIGS. 6A to 6C, a progressive value further increases, so that a jackpot corresponding to “MEGA” is to be paid out.

In FIG. 6A, each of the symbols “office building” 123a, “car” 125, and “villa” 128 is rearranged on the first column. The second to fifth column display effect images in a scrolling manner. In this case, the symbol “office building” 123a and a symbol “tower” 123e shown in FIG. 6B are set to step-up symbols making up one symbol group. An added-value of the symbol “tower” 123e is higher than that of the symbol “office building” 123a. A grade of the jackpot to be awarded is “MEGA”, so that a group containing the symbol “tower” 123e is selected as a symbol group corresponding to a bonus.

In FIG. 6B, the symbols “main character” 121a, “sub character” 122, and “jet” 127 are rearranged on the second column while the symbol “tower” 123e is rearranged on the third column. The fourth and fifth columns display effect images in a scrolling manner. The symbol “office building” 123a previously rearranged on the first column is replaced with the symbol “tower” 123e. The symbol “tower” 123e is set to a step-up symbol, thereby being controlled to be displayed in preference to each of the symbols “car” 125 and “villa” 128 that are previously rearranged on the first column.

In FIG. 6C, the symbols “sub character” 122, “car” 125, “stock certificate” 126 are rearranged on the fourth column while the symbol “tower” is rearranged on the fifth column. Rearrangement of the three symbols “tower” 123e ultimately determines the bonus award corresponding to “MEGA” in terms of screen display.

Next, a process executed in the slot machine 10 according to the embodiment of the present invention, will be described in detail with reference to the drawings. The main CPU 41 controls the progress of a game by reading and executing the game program from the RAM 43.

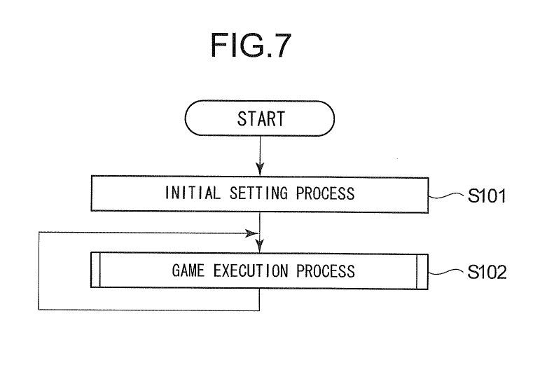

FIG. 7 is a flowchart showing a subroutine of the main process. In the main process, first, when a power switch is turned on (that is, when power is supplied), a motherboard 40 and a gaming board 50 are activated respectively, so that the CPU 51 executes an initial setting process (step S101). In this initial setting process, the main CPU 41 executes the BIOS stored in the ROM 42, decompresses, in the RAM 43, compressed data included in the BIOS, executes the BIOS decompressed in the RAM 43, and performs diagnosis and initialization of each of the peripheral devices. The main CPU 41 writes game programs or the like from memory card 53 into the RAM 43, and retrieves data for setting a payout ratio and country-identification information. The main CPU 41 also performs an authentication process for each program during execution of the initial setting process.

Next, the main CPU 41 performs a game execution process described later with reference to FIG. 8 (step S102). In this game execution process, the main CPU 41 sequentially reads and executes the game programs or the like from the RAM43. By performing this game execution process, the slot machine 10 executes the game according to the embodiment of the present invention. The game execution process is repeatedly performed while power is supplied to the slot machine 10.

FIG. 8 is a flowchart showing a subroutine of the game execution process invoked and performed at step S102 of the subroutine shown in FIG. 7. First, the main CPU 41 judges whether a coin has been bet or not (step S201). Specifically, the main CPU 41 judges whether or not an input signal has been received. The input signal is output from the 1-BET switch 26S at the time of operation of the 1-BET button 26 or output from the MAX-BET switch 27S at the time of operation of the MAX-BET button 27. The main CPU 41 controls the current step to return to the process at step S201 upon judging that no coin has been bet (step S201: NO).

Next, the main CPU 41 subtracts the number of bet coins from the credit amount stored in the RAM 43 (step S202) upon judging that a coin has been bet (step S201: YES). In the case where the number of bet coins is larger than the credit amount stored in the RAM 43, the main CPU 41 controls the current step to return to step S201 without performing the process for subtracting the number of bet coins from the credit amount stored in the RAM 43. In the case where the number of bet coins exceeds the upper limit (fifty coins in this embodiment) of coins that can be bet in one game, the main CPU 41 controls the process to shift to step S201 without performing the process for subtracting the number of bet coins from the credit amount stored in the RAM 43.

Next, the main CPU 41 judges whether or not the start button 23 has been set to ON (step S203). Specifically, the main CPU 41 judges whether or not an input signal has been received, the signal being output from the start switch 23S when the start button 23 is pushed. The main CPU 41 controls the step to return to step S201 upon judging that the start button 23 has not been set to ON (step S203: NO). Where the start button 23 has not been set to ON (for example, where an instruction has been input to terminate the game without setting the start button 23 to ON), the main CPU 41 cancels acceptance of a subtraction result at step S202.

On the other hand, the main CPU 41 performs a symbol rearrangement process (step S204) upon judging that the start button 23 has been set to ON (step S203: YES). Specifically, the CPU 41 executes a program stored in the RAM 43 and samples a plurality of random numeric values corresponding to the symbol matrix SM from among predetermined random numbers. The CPU 41 then compares the sampled random numeric values to symbol weighting data which comes under a predetermined numerical range. The CPU 41 determines the symbol to be rearranged in the symbol matrix from among the symbols, “main character” 121a, “sub character” 122, “office building” 123a, “gold bullion” 124a, “car” 125, “stock certificate” 126, “jet” 127, “villa” 128, and “blank” (see FIG. 4A).

Next, the main CPU 41 judges whether a prize has been established or not (step S205). Specifically, the main CPU 41 judges whether or not a combination of symbols rearranged in the symbol matrix SM results in a winning combination allowed to award any of payouts. Herein, the prize has been established on condition that the three or more symbols of the same type are rearranged in the symbol matrix SM (see FIG. 4B).

Next, upon judging that the prize has been established (step S205: YES), the main CPU 41 performs a predetermined coin-payout process (step S206). In the coin-payout process, the main CPU 41 transmits the control signal to the hopper 66 to pay out the predetermined amount of coins. The CPU 41 may control the process to add the credit corresponding to the coins to be paid out to the credit amount stored in the RAM 43.

Next, the CPU 41 judges whether a free game trigger has been established or not (step S207) when judging that the prize is not established (step S205: NO) or after executing the payout process at step S206. Specifically, the main CPU 41 executes the program stored in the RAM 43 to sample the random numeric value corresponding to the symbol “main character” 121a from a numerical range which comes under a predetermined range of random numeric values, thereby judging whether or not the symbol “main character” 121a is rearranged based on the sampled random numeric values. The main CPU 41 then counts the number of the rearranged symbols “main character” 121a and judges that the free game trigger has been established when the three or more symbols “main character” 121a are rearranged. The main CPU 41 performs the free game execution process (step S208) when judging that the free game trigger has been established (step S207: YES). In this free game execution process, the main CPU 41 reads and executes game programs or the like out of the RAM 43 in sequence, thereby executing the free game execution process. On the other hand, the main CPU 41 terminates the game execution process when judging that the free game is not established at step S207 (step S207: NO) or when executing the process at step S209.

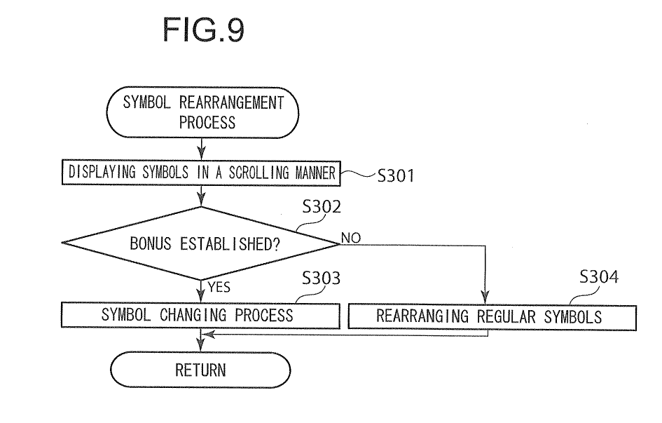

FIG. 9 is a flowchart showing a subroutine of the symbol combining process invoked and performed at step S303 of the subroutine shown in FIG. 8. First, the main CPU 41 displays the symbols in a scrolling manner (step S301). Specifically, the main CPU 41 executes the program stored in the RAM 43 to display effect images that are virtually recognized as if the symbols are scrolled at high speed in a downward direction of the columns of the symbol matrix.

Next, the main CPU 41 judges whether the bonus has been established (step S302), before rearranging symbols. Specifically, the main CPU 41 executes the program stored in the RAM 43 to sample the random numeric value corresponding to the predetermined bonus symbol from a numerical range which comes under a predetermined range of random numeric values, thereby determining based on the sampled random numeric value, the number of predetermined symbols that are rearranged in the symbol matrix SM. The main CPU 41 judges that the bonus has been established when determining the three or more bonus symbols are rearranged.

Upon judging that the bonus has been established (step S302: YES), the main CPU 41 performs a process at step S303. Upon judging that the bonus has not been established (step S302: NO), the main CPU 41 executes a process at step S304.

The main CPU 41 selects a symbol group corresponding to the established bonus, thereby stepping up and rearranging the corresponding symbol at every stop of rotation of columns (see FIGS. 1A to 1C, 5A to 5C, 6A to 6C, and 10).

The main CPU 41 rearranges a regular symbol in the symbol matrix (step S305). Specifically, the main CPU 41 executes the program stored in the RAM 43 to compare, from among a predetermined range of random numbers, a numeric value range determined based on each symbol weighting data to a random numeric value generated correspondingly to each element of the symbol matrix SM, thereby determining the symbol to be arranged in each element of the symbol matrix, from among the group of symbols selected at step S303 or S304.

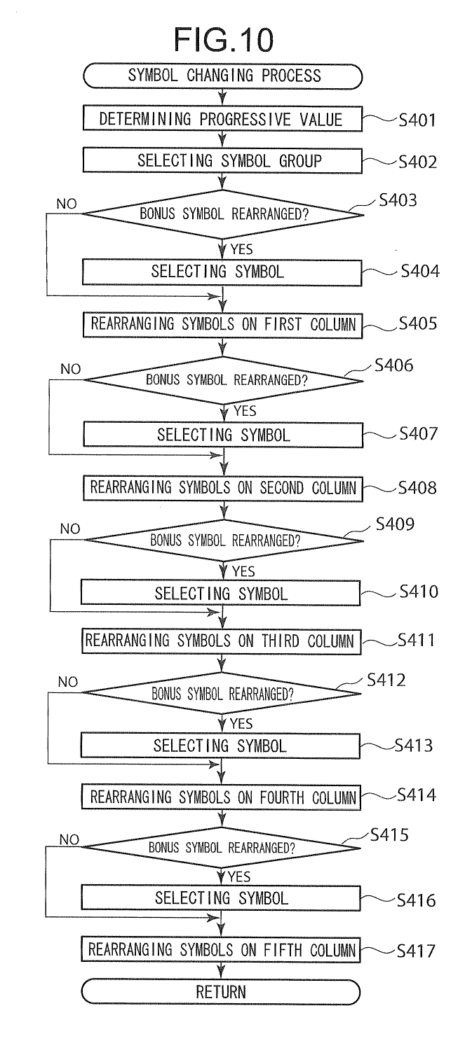

FIG. 10 is a flowchart showing a subroutine of the symbol changing process invoked and performed at step S303 of the subroutine shown in FIG. 9. First, the main CPU 41 reads a cumulative value of part of bet credit that is cumulatively stored in the RAM 43 from a predetermined memory region thereof, thereby determining the amount of bonus payout (step S401).

The main CPU 41 determines the bonus payout from among “MFN”, “MAJOR”, and “MEGA”, thereby selecting the corresponding symbol group (see FIGS. 1A to 1C, 5A to 5C, and 6A to 6C, step S402). The main CPU 41 selects the symbol group containing the symbol “bonus character” 121e in the case of “MIN”, the symbol group containing the symbol “gold bullion tower” 124e in the case of “MAJOR”, and the symbol group containing the symbol “tower” 123e in the case of “MEGA” (see FIGS. 1A to 1C, 5A to 5C, and 6A to 6C).

The main CPU 41 then judges whether or not the bonus symbol is arranged on the first column of the symbol matrix SM (step S403). Specifically, the main CPU 41 judges whether or not the bonus symbol is arranged by referring to a random numeric value range assigned to the bonus symbol and random numeric value of the symbol determined to be rearranged on the first column.

Upon judging that the bonus symbol is rearranged on the first column (step S403: YES), the main CPU 41 selects a symbol expressing the lowest added-value from among symbols belonging to the symbol group selected at the step S402 and rearranges the selected symbol in matrix elements of the first column on which the bonus symbol is to be rearranged (see FIGS. 1A, 5A, and 6A, step S405). On the other hand, upon judging that the bonus symbol is not rearranged on the first column (step S403: NO), the main CPU 41 rearranges a corresponding symbol from among the symbols “main character” 121a, “sub character” 122, “office building” 123a, “gold bullion” 124a, “car” 125, “stock certificate” 126, “jet” 127, and “villa” 128 that do not belong to the symbol group selected at step S402 (step S405).

The main CPU 41 then judges whether or not the bonus symbol is arranged on the second column of the symbol matrix SM (step S406). In the case of judging that the bonus group is rearranged on the second column (step S406: YES) on the condition that the symbol belonging to the symbol group selected at step S402 is rearranged on the first column, the main CPU 41 selects the symbol expressing the higher added-value than that of the symbol rearranged on the first column (step S407), thereby rearranging the selected symbol in the matrix element of the second column on which the bonus symbol is rearranged. On the other hand, where the bonus symbol is not rearranged on the first column, the main CPU 41 selects the symbol expressing the lowest added-value from among the symbols belonging to the symbol group selected at step S402, thereby rearranging the selected symbol (step S408).

In the case of judging that the bonus symbol is not rearranged on the second column (step S406: NO), the main CPU 41 rearranges a corresponding symbol from among the symbols “main character” 121a, “sub character” 122, “office building” 123a, “gold bullion” 124a, “car” 125, “stock certificate” 126, “jet” 127, and “villa” 128 that do not belong to the symbol group selected at step S402 (see FIGS. 5B and 6B, step S408).

Next, the main CPU 41 judges whether or not the bonus symbol is arranged on the third column of the symbol matrix SM (step S409). In the case of judging that the bonus group is rearranged on the third column (step S406: YES) on the condition that the symbol belonging to the symbol group selected at step S402 is rearranged on the first or second column, the main CPU 41 selects the symbol expressing the higher added-value than that of the previously-rearranged symbol (step S410), thereby rearranging the selected symbol in the matrix element of the third column on which the bonus symbol is rearranged (see FIGS. 5B and 6B, step S411). On the other hand, where the bonus symbol is not rearranged on the first or second column, the main CPU 41 selects the symbol expressing the lowest added-value from among the symbols belonging to the symbol group selected at step S402 (step S410), thereby rearranging the selected symbol (step S411).

In the case of judging that the bonus symbol is not rearranged on the third column (step S409: NO), the main CPU 41 rearranges a corresponding symbol from among the symbols “main character” 121a, “sub character” 122, “office building” 123a, “gold bullion” 124a, “car” 125, “stock certificate” 126, “jet” 127, and “villa” 128 that do not belong to the symbol group selected at step S402 (see FIGS. 5B and 6B, step S411).

The main CPU 41 then judges whether or not the bonus symbol is arranged on the fourth column of the symbol matrix SM (step S412) In the case of judging that the bonus group is rearranged on the fourth column (step S412: YES) on the condition that the symbol belonging to the symbol group selected at step S402 is rearranged on the first, second, or third column, the main CPU 41 selects the symbol expressing the higher added-value than that of the previously-rearranged symbol (step S413), thereby rearranging the selected symbol in the matrix element of the fourth column on which the bonus symbol is rearranged (step S414). On the other hand, where the bonus symbol is not rearranged on the first, second, or third column, the main CPU 41 selects the symbol expressing the lowest added-value from among the symbols belonging to the symbol group selected at step S402 (step S413), thereby rearranging the selected symbol (step S414).

In the case of judging that the bonus symbol is not rearranged on the fourth column (step S412: NO), the main CPU 41 rearranges a corresponding symbol from among the symbols “main character” 121a, “sub character” 122, “office building” 123a, “gold bullion” 124a, “car” 125, “stock certificate” 126, “jet” 127, and “villa” 128 that do not belong to the symbol group selected at step S402 (see FIGS. 5B and 6B, step S414).

The main CPU 41 then judges whether or not the bonus symbol is arranged on the fifth column of the symbol matrix SM (step S415). In the case of judging that the bonus group is rearranged on the fifth column (step S415: YES) on the condition that the symbol belonging to the symbol group selected at step S402 is rearranged on the first, second, third, or fourth column, the main CPU 41 selects the symbol expressing the higher added-value than that of the previously-rearranged symbols (step S416), thereby rearranging the selected symbol in the matrix element of the fifth column on which the bonus symbol is rearranged (step S417). On the other hand, where the bonus symbol is not rearranged on the first, second, third, or fourth column, the main CPU 41 selects the symbol expressing the lowest added-value from among the symbols belonging to the symbol group selected at step S402 (step S416), thereby rearranging the selected symbol (step S417)

In the case of judging that the bonus symbol is not rearranged on the fifth column (step S452: NO), the main CPU 41 rearranges a corresponding symbol from among the symbols “main character” 121a, “sub character” 122, “office building” 123a, “gold bullion” 124a, “car” 125, “stock certificate” 126, “jet” 127, and “villa” 128 that do not belong to the symbol group selected at step S402 (see FIGS. 5B and 6B, step S414).

In the case where the step-up symbol in the symbol group selected at step S402 is rearranged in the symbol changing process, and the previously-rearranged step-up symbols express the highest added-values among the symbol group, the symbol expressing the same highest added-value is rearranged later. In the case where the step-up symbols that are longitudinally extended (see FIGS. 5B, 5C, 6B, and 6C) are mutually superimposed, the main CPU 41 exercises control so as to prevent superimposition of the symbols by changing positions of matrix elements in which the symbols are displayed.

While the embodiment according to the present invention has been described, the description presents only some of the specific examples and is not intended to limit the present invention in any way and specific constructions of each means and the like can be properly changed in terms of design. Besides, the effects described in the embodiment of the present invention are only the most preferable effects generated from the present invention and the effects to be caused by the present invention is not limitative thereto.

What is claimed is:

1. A slot machine, comprising:
a display device having a symbol display region for displaying plural types of symbols;
a memory for storing image data concerning the plural types of symbols; and
a processor for controlling the display device and the memory,
the plural types of symbols containing a plurality of symbol groups;
each of the symbol groups being made up of a plurality of step-up symbols;
each of the step-up symbols expressing a different added-value; and
the processor being programmed to:
(a) read the image data concerning the plural types of symbols from the memory;
(b) execute a game by processing the image data, the game for rearranging the plural types of symbols in the symbol display region;
(c) rearrange at least the one or more symbols, in the case where the two or more symbols are rearranged in the symbol display region, in a predetermined period of time delay after previous symbol arrangement; and
(d) exercise control to set the symbol rearranged in the predetermined period of time delay to a step-up symbol expressing an added-value higher than that of the previously-rearranged symbol, in the case where these symbols belong to the same symbol group.

2. The slot machine according to claim 1, wherein:
the processor replaces the previously-rearranged symbol belonging to the same symbol group with the step-up symbol expressing the higher added-value, in the case where the step-up symbol expressing the higher added-value is rearranged in the itemized (d).

3. The slot machine according to claim 1, wherein:
the processor exercises control in a manner to display an image of the step-up symbol in the case where the image of the step-up symbol is superimposed on an image of an adjacent symbol.

4. The slot machine according to claim 1, wherein;
the processor awards a payout corresponding to the added-value of the step-up symbol rearranged in the itemized (d), in the case where a predetermined condition is met.

5. A slot machine, comprising:
a display device having a symbol display region for displaying plural types of symbols;
a memory for storing image data concerning the plural types of symbols; and
a processor for controlling the display device and the memory,
the plural types of symbols containing a plurality of symbol groups;
each of the symbol groups being made up of a plurality of step-up symbols;
each of the step-up symbols expressing a different added-value; and
the processor being programmed to:
(a) read the image data concerning the plural types of symbols from the memory;
(b) execute a game by processing the image data, the game for rearranging the plural types of symbols in the symbol display region;
(c) rearrange at least the one or more symbols, in the case where the two or more symbols are rearranged in the symbol display region, in a predetermined period of time delay after previous symbol arrangement;
(d) exercise control to set the symbol rearranged in the predetermined period of time delay to a step-up symbol expressing an added-value higher than that of the previously-rearranged symbol, in the case where these symbols belong to the same symbol group; and
(e) replace the previously-rearranged symbol belonging to the same symbol group with the step-up symbol expressing the higher added-value that is rearranged in the predetermined period of time delay.

6. The slot machine according to claim 5, wherein:
the processor exercises control in a manner to display an image of the step-up symbol in the case where the image of the step-up symbol is superimposed on an image of an adjacent symbol.

7. The slot machine according to claim 5, wherein;
the processor awards a payout corresponding to the added-value of the step-up symbol rearranged in the itemized (d), in the case where a predetermined condition is met.

8. A slot machine, comprising:
a display device having a symbol display region for displaying plural types of symbols;
a memory for storing image data concerning the plural types of symbols; and
a processor for controlling the display device and the memory,
the plural types of symbols containing a plurality of symbol groups;
each of the symbol groups being made up of a plurality of step-up symbols;
each of the step-up symbols expressing a different added-value; and
the processor being programmed to:
(a) read the image data concerning the plural types of symbols from the memory;
(b) execute a game by processing the image data, the game for rearranging the plural types of symbols in the symbol display region;
(c) rearrange at least the one or more symbols, in the case where the two or more symbols are rearranged in the symbol display region, in a predetermined period of time delay after previous symbol arrangement;
(d) exercise control to set the symbol rearranged in the predetermined period of time delay to a step-up symbol expressing an added-value higher than that of the previously-rearranged symbol, in the case where these symbols belong to the same symbol group; and
(e) replace the previously-rearranged symbol belonging to the same symbol group with the step-up symbol expressing the higher added-value that is rearranged in the predetermined period of time delay.
(f) exercise control to display an image of the step-up symbol in the case where the image of the step-up symbol is superimposed on an image of an adjacent symbol.

9. The slot machine according to claim 8, wherein:
the processor awards a payout corresponding to the added-value of the step-up symbol rearranged in the itemized (d), in the case where a predetermined condition is met.
